(19) United States
(12) Patent Application Publication
(10) Pub. No.: US 2011/0232542 A1
(43) Pub. Date: Sep. 29, 2011

(54) SECURITY CABINET

(75) Inventors: Wilfried Rostek, Paderborn (DE); Markus Müller, Paderborn (DE)

(73) Assignee: BENTELER AUTOMOBILTECHNIK GMBH, Paderborn (DE)

(21) Appl. No.: 13/123,679

(22) PCT Filed: Oct. 21, 2009
(86) PCT No.: PCT/DE2009/001476

§ 371 Date: Apr. 11, 2011

(30) Foreign Application Priority Data
Oct. 22, 2008 (DE) 10 2008 052 632.0

(51) Int. Cl. E05G 1/024; E05G 1/00; G07G 5/00

(52) U.S. Cl. 109/24.1; 109/85; 109/79

(57) ABSTRACT

A security cabinet having a housing and a door mounted on the housing, the housing and the door being produced from metal plates, characterized in that the metal plates of the housing and/or of the door are made of steel having the following composition stated in percent by weight: carbon 0.1 to 0.5%, silicon 0.1 to 1.0%, manganese 0.2 to 2.0%, phosphorus max. 0.02%, sulfur max. 0.02%, aluminum max. 0.1%, copper max. 0.5%, chromium 0.05 to 18%, nickel max. 2.0%, molybdenum 0.1 to 1.0%, boron 0.0005 to 0.01%, tungsten 0.001 to 1.0%, nitrogen max. 0.05%, titanium max. 0.5%, vanadium max. 0.5%, niobium max. 0.5%, the remainder being iron and impurities caused by the melting process, wherein the metal plates are hot formed.

The invention relates to a security cabinet having the features of patent claim 1.

Security cabinets, also designated as safe deposit boxes, safes, or vaults, steel cabinets, or strongboxes, have many designs in the state of the art. Security cabinets are also used for automated teller machines. Automated teller machines normally include a standard industrial PC with connected special periphery and a security cabinet which stores the cash in cartridges to protect the cash from access by third parties.

Such a security cabinet is normally made from flat steel plates which are welded in the corners. The corpus may also be formed from two or multi-layered material combinations to provide an increased protection against mechanical and thermal threats, like for example cutting by means of cutting wheels or flame cutting.

In addition to the typical break-open operations by drilling or cutting, blasting poses increasingly a threat. This involves the conduction of a combustible gas through a small opening into the interior of the security cabinet and then igniting it. As a result, the door hinges and locking mechanism are exposed to excess stress and thus become dislodged. Moreover, the high pressures may cause the corpus to deform so that the weld seams in the corners break open.

Conventional security cabinets have the further drawback that the great wall thickness makes them very heavy. On one hand, this may be desired in order to make the transport more difficult. The substantially more difficult transport is however disadvantageous because it complicates placement of the automated teller machines. Furthermore, a greatest possible interior space is desired in security cabinets of automated teller machines because the storage cartridges for money and the complex conveyor systems for the bills require much space.

DE 10 2005 014 298 A1 belongs to the technological background and discloses a vehicle armor.

DE 1 250 642 B describes the use of an age-hardenable nickel-chromium alloy with improved strength properties.

The invention is therefore based on the object to provide a security cabinet made of metal plates which has, on one hand, a slight wall thickness and thus permits a weight reduction and optimum interior space utilization, and on the other hand can be manufactured in such a way that the geometry of the metal plates can be suited to the stress caused by blasting and acting from the inside against the security cabinet.

This object is solved by a security cabinet having the features of patent claim 1.

Advantageous refinements of the inventive ideas are the subject matter of the sub-claims.

The security cabinet according to the invention is characterized in that the metal plates of the housing and/or the door are made of a steel having the following composition expressed in weight percent:

| | |
|---|---|
| carbon | 0.1 to 0.5% |
| silicon | 0.1 to 1.0% |
| manganese | 0.2 to 2.0% |
| phosphorus | max. 0.02% |
| sulfur | max. 0.02% |
| aluminum | max 0.1% |
| copper | max. 0.5% |
| chromium | 0.05 to 18% |
| nickel | max. 2.0% |
| molybdenum | 0.1 to 1.0% |
| boron | 0.0005 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities. The metal plates are hereby hot-formed and contoured in order to weld them with neighboring metal plates to form the housing of the security cabinet.

Hot formed tempering steels are characterized by their great hardness and tensile strength. As a result, these steels provide increased resistance against drilling, permitting a decrease in wall thickness. The decrease in wall thickness, rendered possible by the invention, results in a larger interior space while maintaining outer dimensions. This is advantageous in particular when security cabinets for automated teller machines are involved. The lesser weight significantly simplifies placement of the automated teller machines because of the decrease in stress on the floors of the buildings as a result of the reduced weight. As a consequence, the need for complicated constructions of reinforcements can be eliminated. Moreover, transport is significantly simplified and more beneficial as a result of the smaller weight. As security cabinets of automated teller machines are secured by being walled in or anchored, a reduced weight of the security cabinet does not adversely affect security.

If, on the other hand, a reduction of the wall thickness of the metal plates is not wanted, the use of the proposed steel alloy increases resistance against the drilling operation.

The metal plates of the housing and/or the door are preferably made from a steel with the following composition expressed in weight percent:

| | |
|---|---|
| carbon | 0.2 to 0.4% |
| silicon | 0.1 to 1.0% |
| manganese | 0.5 to 2.0% |
| phosphorus | max. 0.02% |
| sulfur | max. 0.02% |
| aluminum | max 0.1% |
| copper | max. 0.5% |
| chromium | 0.05 to 0.5% |
| nickel | max. 2.0% |
| molybdenum | 0.1 to 1.0% |
| boron | 0.0008 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities.

As an alternative, the metal plates of the housing and/or door are made from a steel with the following composition expressed in weight percent:

| | |
|---|---|
| carbon | 0.1 to 0.5% |
| silicon | 0.1 to 1.0% |
| manganese | 0.2 to 2.0% |
| phosphorus | max. 0.02% |
| sulfur | max. 0.02% |
| aluminum | max 0.1% |
| copper | max. 0.5% |
| chromium | 5 to 18% |
| nickel | max. 2.0% |
| molybdenum | 0.1 to 1.0% |
| boron | 0.0005 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities.

The preceding steel alloy has increased chromium content. In view of the great hardness that can be realized, the steel is well suited against mechanical attacks. In view of the higher chromium content, the steel exhibits a better resistance against thermal attacks by autogenous flame cutting or the like.

According to the invention, the metal plates are hot formed. In the preferred state, the panels rolled in the rolling mill are processed in the non-hardened, soft state and shaped through hot forming and tool hardening into the desired structure. In the hot forming process, the blank is heated before the final shaping step to a temperature above the AC₃ point and thereafter shaped in a press tool in which it is preferably also hardened. Hardening in the tool progresses for a period should have progressed long enough that no distortion or only negligible distortion is encountered when opening the tool. It is thus not necessarily required to carry out the hardening to the martensitic finishing temperature in the tool. The subsequent cooling to room temperature can therefore also take place in the opened tool or also outside the tool. This procedure permits the production of hot formed metal plates of great hardness and tensile strength with good dimensional accuracy.

The steel is alloyed with boron to render the steel hardenable. To suppress formation of boron nitrite and prevent unbound boron in the steel, the steel is alloyed with titanium. As a result, titanium nitrite is preferably formed so that boron is made available for hardenability of the steel. In accordance with the invention, it is provided that titanium in relation to the nitrogen content is added by alloying at a ratio of 3.0 to 4.0. Ideally, titanium is added by alloying in relation to nitrogen at a ratio of Ti/N of 3.4.

The metal plates have a tensile strength of 1200 to 2000 MPa and a hardness of 300 to 600 HV30.

It is further considered suitable to carburize the steel up to a depth of 2 mm with a limit carbon content of up to 0.8%. Case hardening results in metal plates having a tough core while at the same time having a hard surface. In this way, the metal plates have the necessary resistance against deformation to withstand explosions but at the same time the required hardness to withstand drilling attempts.

Following carburization, the metal plates undergo the actual hardening process. In this way, the hardness penetration profile characteristic for the material is realized. Optionally, tempering may promptly follow hardening in order to provide the hard martensitic skin with slightly more ductility.

It is also theoretically possible to utilize the used steel grade as hardened flat plate. In this case, shaping operations can be realized however only to a limited extent. Single parts would have to be cut by laser out of the flat plate and connected to one another. It is considered more advantageous to connect hot formed metal plates of the housing with one another by material joint, with the butt joints of interconnected metal plates situated outside the corner regions of the housing. The metal plates are therefore configured of L-shaped or U-shaped cross section and are thus welded and/or soldered outside the corner regions. In this way, the stress critical corner regions do not experience an additional weakening in the area of the welding zone as a result of changes in the microstructure caused by heat.

The housing can be rounded in the corner region as a result of hot forming of the metal plates and shift of the weld seam position, thereby providing greater capability to resist blasts acting from the inside. This can also be attributed to the fact that butt-welded seams have advantages compared to fillet welds.

It is possible to manufacture the securing cabinet from material composites. In particular, the housing may be multilayered, with the metal plates made from the steel grade used within the scope of the invention and forming the outer shell of the housing/door. In a manner known per se, combinations with further metallic plates, plastics, insulating materials, or also mineral materials, like concrete, are conceivable as well within the scope of the invention. In a multilayered configuration, the steel grade according to the invention is, of course, not only applicable for the outer shell but also the inner shell of the housing/door may be manufactured from the steel grades according to the invention.

Wall thicknesses of the metal plates of 2.5 mm to 15 mm have been shown in practice as especially advantageous. Preferably, the wall thickness is between 4 mm and 6 mm. Compared to conventional security cabinets, in particular vaults, a significant weight decrease can be realized.

It is furthermore advantageous to provide the metal plates of the security cabinet with a stiffness-increasing structure. Such a stiffness-increasing structure can be realized through formation of embossments and/or indentations in the surface of the metal plates or also by folding the marginal areas. The implementation of the stiffness-increasing structure in the metal plate takes place preferably during the hot forming process with subsequent press hardening. The stiffness-increasing structure stiffens the walls of the security cabinet and thus the resistance against denting. As a result, the resistance against mechanical attacks, for example prying open the walls, can be increased.

What is claimed is:

1.-15. (canceled)

16. A security cabinet, comprising:
a housing; and
a door supported on the housing,
wherein the housing and the door are formed of metal plates made of a steel having the following composition expressed in weight percent:

| | |
|---|---|
| carbon | 0.1 to 0.5% |
| silicon | 0.1 to 1.0% |
| manganese | 0.2 to 2.0% |
| phosphorus | max. 0.02% |
| sulfur | max. 0.02% |
| aluminum | max 0.1% |
| copper | max. 0.5% |
| chromium | 0.05 to 18% |
| nickel | max. 2.0% |
| molybdenum | 0.1 to 1.0% |
| boron | 0.0005 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities,
wherein the metal plates are hot-formed.

17. The security cabinet of claim 16, wherein the steel has the following composition expressed in weight percent:

| | |
|---|---|
| carbon | 0.2 to 0.4% |
| silicon | 0.1 to 1.0% |
| manganese | 0.5 to 2.0% |
| phosphorus | max. 0.02% |
| sulfur | max. 0.02% |
| aluminum | max 0.1% |
| copper | max. 0.5% |
| chromium | 0.05 to 0.5% |
| nickel | max. 2.0% |
| molybdenum | 0.1 to 1.0% |
| boron | 0.0008 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities.

18. The security cabinet of claim 16, wherein the steel has the following composition expressed in weight percent:

| | |
|---|---|
| carbon | 0.1 to 0.5% |
| silicon | 0.1 to 1.0% |
| manganese | 0.2 to 2.0% |
| phosphorus | max. 0.02% |
| sulfur | max. 0.02% |
| aluminum | max 0.1% |
| copper | max. 0.5% |
| chromium | 5 to 18% |
| nickel | max. 2.0% |
| molybdenum | 0.1 to 1.0% |
| boron | 0.0005 to 0.01% |
| tungsten | 0.001 to 1.0% |
| nitrogen | max. 0.05% |
| titanium | max. 0.5% |
| vanadium | max. 0.5% |
| niobium | max. 0.5% |

remainder iron and incidental smelting-related impurities.

19. The security cabinet of claim 16, wherein the steel has a ratio of titanium to nitrogen of 3.0 to 4.0.

20. The security cabinet of claim 16, wherein the steel has a ratio of titanium to nitrogen of 3.4.

21. The security cabinet of claim 16, wherein the metal plates have a tensile strength of 1200 to 2000 MPa.

22. The security cabinet of claim 16, wherein the metal plates have a hardness of 300 to 600 HV30.

23. The security cabinet of claim 16, wherein the metal plates have a limit carbon content of up to 0.8% in their skin up to a depth of 2 mm.

24. The security cabinet of claim 16, wherein the metal plates are hardened and tempered.

25. The security cabinet of claim 16, wherein the metal plates of the housing are connected to one another by material joint.

26. The security cabinet of claim 25, wherein butt joints of interconnected metal plates are situated outside of corner regions of the housing.

27. The security cabinet of claim 16, wherein the housing and/or door have a multilayered configuration, with the metal plates forming an outer shell of the housing and/or door.

28. The security cabinet of claim 16, wherein the metal plates form an inner shell of the housing and/or door.

29. The security cabinet of claim 16, wherein the metal plates have a wall thickness between 2.5 mm and 15 mm.

30. The security cabinet of claim 16, wherein the metal plates have a wall thickness between 4 mm and 6 mm.

31. The security cabinet of claim 16, wherein the metal plates have a stiffness-increasing structure.

32. The security cabinet of claim 16, for use as a safe, steel cabinet, strongbox, or a vault.

33. The security cabinet of claim 16, for use as component of an automated teller machine.
